(19) United States
(12) Patent Application Publication
(10) Pub. No.: US 2023/0077278 A1
(43) Pub. Date: Mar. 9, 2023

(54) Artificial Reality Content Management

(71) Applicant: Meta Platforms Technologies, LLC, Menlo Park, CA (US)

(72) Inventors: Miguel GONCALVES, Redwood City, CA (US); Hsin-Yao LIN, San Jose, CA (US); Patrick BENJAMIN, Ridgefield, WA (US); Yiting LI, Mountain View, CA (US); Chun-Wei CHAN, Foster City, CA (US); Yinglong XIA, Saratoga, CA (US); Jiajie TANG, Fremont, CA (US); Jeffrey Thomas CLARKE, Brooklyn, NY (US); Erik Christopher LARSSON, Newark, CA (US); Rachel CIAVARELLA, Brooklyn, NY (US); Marco Andre LOURENÇO DE SOUSA, New York, NY (US)

(73) Assignee: Meta Platforms Technologies, LLC, Menlo Park, CA (US)

(21) Appl. No.: 18/055,114

(22) Filed: Nov. 14, 2022

Related U.S. Application Data
(60) Provisional application No. 63/336,468, filed on Apr. 29, 2022.
(60) Provisional application No. 63/333,675, filed on Apr. 22, 2022.
(60) Provisional application No. 63/333,601, filed on Apr. 22, 2022.
(60) Provisional application No. 63/304,765, filed on Jan. 31, 2022.

(51) Int. Cl. G06T 19/00; H04L 9/32

(52) U.S. Cl. CPC G06T 19/006; H04L 9/3213; H04L 2209/60

(57) ABSTRACT

Some aspects of the disclosed technology can create a virtual object based on user container selections. Further aspects of the disclosed technology can provide one or more product recommendations corresponding to a current context of user activity. Additional aspects of the disclosed technology can generate and export non-fungible tokens using object recognition. Yet further aspects of the disclosed technology can augment a digital environment with NFT content corresponding to an NFT wallet.

### CROSS REFERENCE TO RELATED APPLICATIONS

This application claims priority to U.S. Provisional Application No. 63/304,765 filed Jan. 31, 2022 and titled “Automatic Converting Content Items to Virtual Objects through Artificial Reality Containers,” 63/333,675 filed Apr. 22, 2022 and titled “Non-Fungible Token Generation and Exportation Using Object Recognition,” 63/336,468 filed Apr. 29, 2022 and titled “Context Driven Recommendation System Maintaining User Privacy,” and 63/333,601 filed Apr. 22, 2022 and titled “NFT Content Placement System.” Each patent application listed above is incorporated herein by reference in their entireties.

### BACKGROUND

Interactions with computing systems are often founded on a set of core concepts that define how users can interact with that computing system. For example, early operating systems provided textual interfaces to interact with a file directory. This was later built upon with the addition of “windowing” systems whereby levels in the file directory and executing applications were displayed in multiple windows, each allocated a portion of a 2D display that was populated with content selected for that window (e.g., all the files from the same level in the directory, a graphical user interface generated by an application, menus or controls for the operating system, etc.) As computing form factors decreased in size and added integrated hardware capabilities (e.g., cameras, GPS, wireless antennas, etc.) the core concepts again evolved, moving to an “app” focus where each app encapsulated a capability of the computing system.

An artificial reality (XR) device, such as an augmented reality (AR) device, mixed reality (MR), or virtual reality (VR) device, can be used to display additional content over a depiction of a real-world environment. For instance, users on an XR device can view objects in an environment or perform social interactions on a social media platform via the XR device. The existing XR systems have generally backed the virtual objects it presented by extending the app core computing concept. For example, a user can instantiate these virtual objects by activating an app and telling the app to create the virtual object, and using the virtual object as an interface back to the app. This approach generally requires simulating, in the virtual space, the types of interactions traditionally performed with mobile devices. This also requires continued execution of the app for the virtual objects to persist in the artificial reality environment. Such existing artificial reality systems typically limit virtual objects to be used by the app that created them, require each user to learn how to use the individual virtual objects crated by each app, and make virtual object development labor intensive and prone to error.

As computing devices continue to proliferate digital items have grown in popularity. Digital images can be displayed by a display device, such as on a website or in an application, and can even be printed to create a real-world representation. Further, digital audio files and video files can be played in the real-world by audio devices and video devices. The rise in digital items has created mechanisms for sharing these items, such as non-fungible tokens, marketplaces to support transactions, and a variety for formatting standards.

A blockchain is a list of records, each called a block, which can be linked through cryptography. Each block includes a timestamp, a hash of the previous block, and transaction data. The timestamp proves that the transaction data was included when the block was added in order to get its hash. Because each block specifies the block previous to it, the set of blocks make a chain, with each new block reinforcing the set of blocks before it in the chain. Therefore, blockchains are very difficult to modify because data, once added to the blockchain, cannot be altered without altering all subsequent blocks.

Non-Fungible Tokens (NFTs), are blockchain-backed identifiers specifying a unique (digital or real-world) item. Through a distributed ledger, the ownership of these tokens can be tracked and verified. Such tokens can link to a representation of the unique item, e.g., via a traditional URL or a distributed file system such as IPFS. While a variety of blockchain systems support NFTs, common platforms that supports NFT exchange allow for the creation of unique and indivisible NFT tokens. Because these tokens are unique, they can represent items such as art, 3D models, virtual accessories, etc.

NFTs represent a way of being able to define ownership for practically anything that is digital. In other words, any material that can be digitized or which is already in a digital format can be the subject of an NFT. Some examples of NFT content can include digital photographs, video frames, social media interactions, and virtually all items that can be converted for receipt and processing by a computer (e.g., a scanned autograph). Increasingly, digital art has grown in popularity as a particular content type that can be bought and sold among members of the NFT community. Finding new ways to display and share this and other types of NFT content can be an attractive means by which to promote interactions among NFT community and other members of an interactive platform for those interactions.

Computing today makes possible an ever increasing number of activities, such as purchasing products, interacting on social media, and engaging in an artificial/virtual reality environment. Options associated with these activities can be overwhelming. Knowing a history of prior activity selections (e.g., a prior click-through, like, share, comment, AR/VR movement, or product purchase, etc.) can provide an ability to guide future selections, and thus enrich an experience for a particular current activity. This is especially true when such guidance is developed using a same or similar context associated with the prior activity selections.

### SUMMARY

Aspects of the present disclosure are directed to an artificial reality container system that enables creation of virtual objects simply by a user selecting an artificial reality container, providing content items, and setting container parameters. The resulting virtual objects can be placed in an artificial reality environment (e.g., by an artificial reality device as a hologram or by mobile device as a camera feed overlay) and can include features that the user did not have to specify such as user interface elements (e.g., controls to move, close, minimize, resize, etc. the virtual object); automatic transitioning between view states (e.g., context depending rules for configuring the virtual object output); tie-ins to other systems such as a social media platform, ecommerce modules, messaging, etc., event listeners and other operating system interfaces; etc.

Further aspects of the present disclosure are directed to generating and exporting non-fungible tokens using object recognition. For example, a digital item manager can receive an image and automatically recognize objects within the image and/or detect characteristics for the recognized objects. According to a user selection of at least one of the recognized objects, the digital item manager can generate A) a digital item that includes a digital representation of the selected object and B) an NFT. For example, configuration data about the user selected objects can be received, and one or more digital items can be generated according to the configuration data. The digital item manager can also receive a selection for one or more digital environments that each include a style protocol. The digital item manager can adapt the digital items into one or more versions of the digital items that comply with each of the style protocols. The digital item manger can then export each version of the digital items to the digital environment that corresponds to the version.

Additional aspects of the present disclosure are directed to providing one or more product recommendations aligned with interests and activities a user of an interactive platform, such as a social media outlet. For the platform, a product recommendation system can track prior and ongoing user engagements transacted via a user's local device and generate a user interest profile accordingly. The profile can represent various topics corresponding to interests and activities of the user for a current context. The product recommendation system can assess these topics against user profiles for a pool of other anonymous users of the platform to determine one or more same or similar contexts for the current context of the user. Using one or more of these same or similar contexts, the product recommendation system can associate one or more products that can then be recommended to the user for the current context.

Aspects of the present disclosure are directed to augmenting a digital environment of an interactive platform, such as a social media outlet, with NFT content of a user. For the platform, an NFT content placement system can connect with a user's NFT wallet and import content corresponding to that wallet into digital media supported by the platform. Once imported, the NFT content placement system can position the NFT content within real and/or virtual spaces for the digital media, and then record those spaces to include such positioning. As a result, the NFT content placement system can enable a user of the platform to customize the digital media according to user preference.

### BRIEF DESCRIPTION OF THE DRAWINGS

FIG. 1 is an example 100 of a user interface for selecting an artificial reality container, content items, and parameters, for a virtual object.

FIG. 2 is an example 200 of content items converted to a virtual object through application of an artificial reality container.

FIG. 3 is a flow diagram illustrating a process 300 used in some implementations for creating a virtual object based on user container selections.

FIG. 4 illustrates a diagram of an example image with multiple objects.

FIG. 5 illustrates a diagram of example objects recognized in an image.

FIG. 6 illustrates a system diagram of example components that generate and export non-fungible tokens using object recognition.

FIG. 7 is a flow diagram illustrating a process 400 used in some implementations for generating and exporting non-fungible tokens using object recognition.

FIG. 8 is an architecture of a product recommendation system used in some implementations for proactively recommending one or more products to a user for respective current contexts of the user's activities.

FIG. 9 is an example of a type of personal knowledge graph that can, in some implementations, demonstrate user activities under certain contexts.

FIG. 10 is an example of a type of profile pool of anonymous user profiles that can, in some implementations, demonstrate corresponding topics of user interest for corresponding contexts.

FIG. 11 is an example of a type of product knowledge graph that can, in some implementations, demonstrate products that the product recommendation system can recommend to a user.

FIG. 12 is an example of a graph that can, in some implementations, demonstrate how the product recommendation system defines a user profile by transforming a user's activities to corresponding topics of user interest.

FIG. 13 is an example of a graph that can, in some implementations, demonstrate how the product recommendation system can identify multiple user profiles for a same user according to different contextual weights for corresponding topics of user interest.

FIG. 14 is a flow diagram illustrating a process used in some implementations for generating one or more product recommendations to be provided to a user for a current context of the user's activities.

FIG. 15 is an exemplary user interface that can provide access to an NFT wallet of a user.

FIG. 16 is an exemplary user interface that can, in some implementations, enable linking of an NFT wallet of a user to an NFT content placement system.

FIG. 17 is an exemplary user interface that can, in some implementations, enable the display and selection of one or more digital collectibles corresponding to an NFT wallet of a user.

FIG. 18 is an exemplary user interface that can, in some implementations, enable placement of NFT content within a digital environment.

FIG. 19 is a flow diagram illustrating a process used in some implementations for placing NFT content within a digital environment.

FIG. 20 is a block diagram illustrating an overview of devices on which some implementations of the present technology can operate.

FIG. 21 is a block diagram illustrating an overview of an environment in which some implementations of the present technology can operate.

### DESCRIPTION

Artificial reality devices can display virtual objects in an artificial reality environment. In various implementations, an artificial reality device can be a mixed reality or virtual reality device that can cause virtual objects to appear to a user as if they are real or can be an augmented reality mobile device (e.g., smartphone, tablet, etc.) that can show a camera feed on a display and incorporate a virtual object as an element in the camera feed (e.g., making a chair appear in a camera feed of user's living room where no real chair exists). In either case, a virtual object provided in an artificial reality environment will include one or more content items (e.g., 3D or 2D visual elements, audio output, animations and transitional items, icons, etc.) but may also need user and system controls such as user interface (UI) elements e.g., to move, size and place the virtual object, event listeners and interfaces for interacting with an operating system or shell application, rules for how the virtual object reacts to other real and virtual objects in the artificial reality environment, tie-ins to other systems such as social media platforms and ecommerce systems, constructor functions and data structures, display templates, a set of physics rules the virtual object uses for physical interactions, etc. However, it can be extremely costly and require significant expertise to be able to create all these non-content item features of a virtual object.

An artificial reality container system can enable creation of virtual objects simply by a user selecting an artificial reality container, providing content items, and setting container parameters. A user can select a container from a set of predefined containers, each having a set of properties such as user interface elements, view states and templates, interfaces to other systems, and rules for interacting with other virtual objects.

For example, a first artificial reality container can be defined for a merchant's catalog of items, where the artificial reality container specifies a set of UI controls to move, size, and place the resulting virtual object in an artificial reality environment, close the virtual object, and set virtual object color and configuration options; a set of social media integrations (e.g., to like and comment on the product); and a set of ecommerce modules. Thus, multiple virtual objects can be defined with a single artificial reality container, e.g., for a catalog of items, and these virtual objects can be instantiated in multiple users' artificial reality environments (i.e., a “see in my 3D world” feature), allowing various interactions such as rotate, zoom, position, color select, etc., without a creator having to define these interactions for each virtual object.

As another example, a second artificial reality container can be defined for storytelling virtual objects, where the artificial reality container specifies a set of UI controls to move, size, and place the resulting virtual object in an artificial reality environment, close the virtual object, trigger animations included in the virtual object, and transition the virtual object between states defined for portions of a story; rules for the virtual object to have certain physics reactions (e.g., defining how it responds to virtual forces applied by the artificial reality environment to virtual objects, such as gravity, inertia, and magnetism); rules for the virtual object to react to surfaces and other virtual objects (e.g., how it combines with other virtual objects when made into a collection, what occurs when other virtual object types are dropped on this virtual object, how the virtual object configures itself when put on a defined type of surface); etc.

Once selected, the artificial reality container can accept various content items. For example, the artificial reality container can have a set of view states such as a maximized view state, a flat panel view state, and a minimized view state. Each view state can have a set of rules defining when it is invoked (e.g., based on the surface type it's on, whether the user is interacting with it, etc.) The user can provide one or more content items for each view state, which the virtual object can display when that view state is enabled. The artificial reality container can also define other content item output, such as animations for transitioning between view states, reactions to user contexts, effects to provide when interacting with other virtual objects, etc., and the user can specify content items (meeting required features such as size, output duration, etc.) for the defined output situations.

A selected artificial reality container can also have zero or more parameters that the user can (or in some cases must) set for the artificial reality container to create a corresponding virtual object. For example, the artificial reality container can be defined to take one or more sizes to display the virtual object for its various view states, a set of physics rules to apply to the virtual object (consistently or for each view state), colors, textures, or skin options a viewer can select for a content item of the virtual object once it's been placed in an artificial reality environment, links to other data structures or systems (e.g., defining a product ID, user ID, social media entity ID, etc.), limits on how the virtual object can be moved or placed in an artificial reality environment (e.g., types of surfaces or anchor points it can be placed on, whether it shows up in relation to another object such as on a user's face, etc.), triggers for displaying the virtual object, etc.

Thus, instead of a virtual object creator having to build each virtual object from the ground up, she can instead use an artificial reality container and change the parameters to match her desired output (e.g., a product listing). For example, a furniture merchant, rather than needing to define a unique virtual object for each of her 100 furniture inventory items, she can select a furniture artificial reality container for all the items in her catalog, import a 3D model of each item, set the furniture parameters such as size and color options, and can get back the set of virtual objects for her customers to use in their artificial reality environments. Thus, the merchant can create virtual objects without having to manually define things like UI controls and a shopping cart module for each virtual object. The resulting virtual objects can be acquired by viewing users and placed in an artificial reality environment (e.g., by an artificial reality device as a hologram or by mobile device as a camera feed overlay).

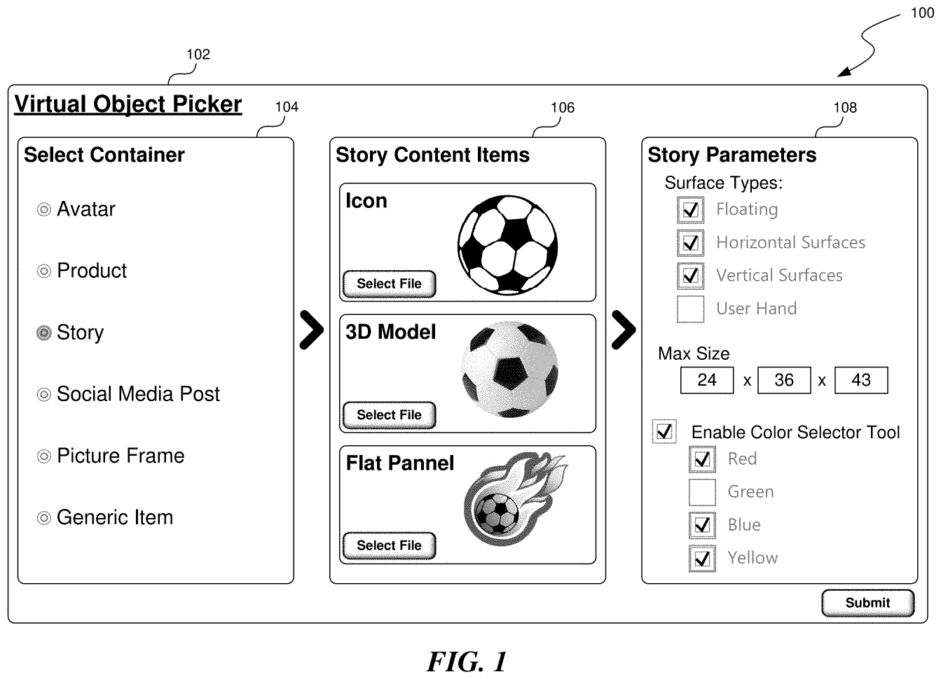

FIG. 1 is an example 100 of a user interface for selecting an artificial reality container, content items, and parameters, for a virtual object. In example 100, a user has accessed a virtual object picker 102, which is an interface for selecting an artificial reality container and associated items for a virtual object. The virtual object picker 102 includes an artificial reality container selector 104, a content item selector 106, and a parameters selector 108.

The artificial reality container selector 104 provides a set of pre-defined artificial reality containers and allows a user to select one. While show as a radio selector, the artificial reality container selector can be in a variety of formats such as a dropdown, a list selector (e.g., from a library of artificial reality containers), a file selector through which the user can upload an artificial reality container definition file, etc.

The content item selector 106 can include interfaces for the user to supply content items, such as with a file selector, a drag/drop interface, a field to enter a URL for content items, etc. In various cases, the content item selector 106 can be generic to all artificial reality containers, facilitating selection of a standard set of content items or any number of content items or the content item selector 106 can be specific to the artificial reality container selected with artificial reality container selector 104—e.g., providing selectors for each type of content item the resulting virtual object will be able to output in various contexts.

The parameters selector 108 can provide interfaces for selection of the parameters defined for the artificial reality container selected in artificial reality container selector 104. In example 100, the artificial reality container selected is for a “story” type of virtual object. This artificial reality container has parameters for the user to select what type of surfaces the resulting virtual object can be added to, a maximum size for the resulting virtual object, and whether a tool should be enabled for the viewing use to select colors for the virtual object and with which colors.

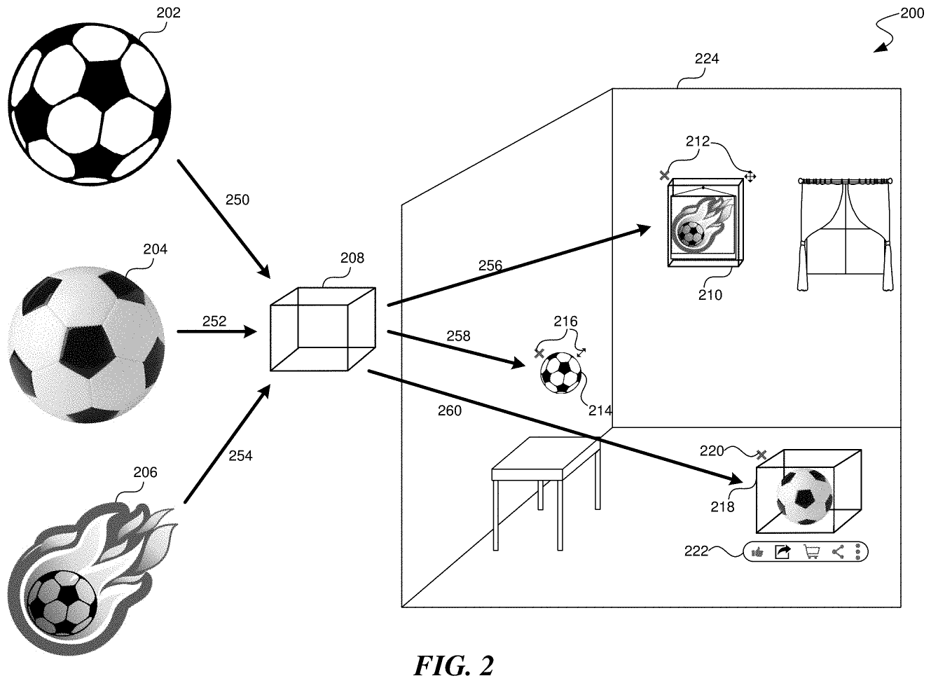

FIG. 2 is an example 200 of content items converted to a virtual object through application of an artificial reality container. In example 200, a user has supplied (at steps 250-254) an icon content item 202, a 3D model content item 204, a flat panel content item 206, and has selected an artificial reality container 208. The artificial reality container 208 defines a first view state for displaying an icon content item when the resulting virtual object is placed to hover in mid-air, a second view state for displaying an 3D model content item when the resulting virtual object is placed on a horizontal surface, and a third view state for displaying a flat panel content item when the resulting virtual object is placed on a vertical surface. At step 256, a first instance of the virtual object 210 has been instantiated in artificial reality environment 224 by being placed on a wall (thus showing in a flat panel state); at step 258, a second instance of the virtual object 214 has been instantiated in artificial reality environment 224 by being placed in mid-air (thus showing in an icon “glint” state); and at step 260, a third instance of the virtual object 218 has been instantiated in artificial reality environment 224 by being placed on a floor (thus showing in a 3D model state). The artificial reality container 208 defines UI elements 212 to be instantiated for the flat panel view state (providing close and move controls); UI elements 216 to be instantiated for the icon view state (providing close and expand controls); and UI elements 220 and 222 to be instantiated for the 3D model view state (providing close, like, save to collection, buy, share, and more options controls). All of which have been created without the user having to manually specify these controls or view states.

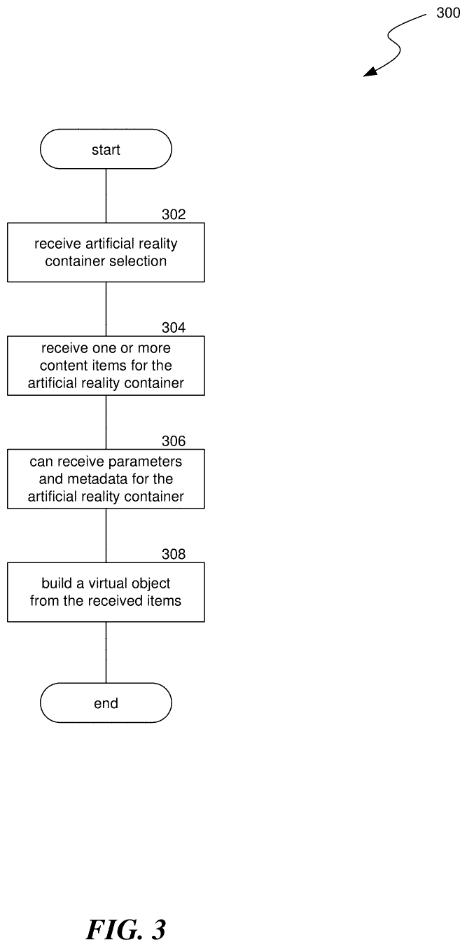

FIG. 3 is a flow diagram illustrating a process 300 used in some implementations for creating a virtual object based on user container selections. Process 300 can be performed in response to a user command, e.g., opening a virtual object creation application, website, or other tool.

At block 302, process 300 can receive a selection of an artificial reality container. The selection can be from a library of predefined artificial reality containers. Each defined artificial reality container can specify artificial reality container properties such as content items that are permitted or required; one or more view states (e.g., templates controlling how a virtual object presents its content items in when in various states and rules or a state machine defining triggers for transitioning between these states); included modules, application tie-ins, or other interfaces; event listeners; user interfaces and controls; etc. Each defined artificial reality container can also specify artificial reality container properties a user can set to customize the resulting virtual object, such as a size, color options, whether the virtual object is moveable and on what types of surfaces or to what type of anchors the virtual object can be added, which tie-in modules to enable, etc.

At block 304, process 300 can receive one or more content items for the artificial reality container. Process 300 can provide a user interface that allows a user to supply content items for the content item slots defined by the artificial reality container. For example, the artificial reality container can specify that at least one 3D model is required and at least one icon is required to generate a virtual object with that artificial reality container, and can specify optional content item slots for transitions between view states, effects to be applied in response to the user picking up the virtual object, a flat view of the virtual object, and audio components to be played upon corresponding triggers. In various implementations, the content items can include, for example, 3D models, 2D images, effect definitions (e.g., a definition of colors and textures to apply such as a makeup application definition), triggered animations and transitional items, icons, audio items, virtual stickers, text, etc.

At block 306, process 300 can receive parameters and metadata for the artificial reality container. The parameters and metadata can define a context of the virtual object such as a title, description, transition triggers, which data elements the virtual object will be associated with (e.g., product ID, user ID, social media element ID, etc.), placement restrictions, which modules and tie-ins should be enabled (e.g., social media controls, ecommerce modules, messaging functions, etc.), which physics rules will be applied to the virtual object, color options, sizes, skins/textures, etc.

At block 308, process 300 can build a virtual object from the received items. Building the virtual object can include filling data fields, defined in the artificial reality container selected at block 302, for content items and parameters with the items selected and defined at blocks 304 and 306. These content items and parameters can be saved in relation to the virtual object. The artificial reality container can define a manifest or constructor function and, when the virtual object is to be instantiated into an artificial reality environment (e.g., upon user selection or in response to another trigger), the manifest can be provided to a shell or the constructor function can be invoked, causing the creation of an instance of the virtual object in the artificial reality environment. Building the virtual object can add various UI and UX elements that will be generated when the virtual object is instantiated such as movement controls, minimize / maximize controls, social media tie-ins (e.g., linking to a social media user or profile, creating corresponding social media posts, integrating “like” and commenting functionality, etc.), a color selector, a snapshot generator (e.g., allowing the user to capture an image of the virtual object in the artificial reality environment), ecommerce tie-ins (e.g., connections to a shopping cart, item catalog, option selector, etc.), defines placement constraints, sets contextual triggers and corresponding view templates for changing view states, sets event listeners and other OS interaction features, provides rules for physical reactions (e.g., based on physics set, object/surface recognition rules, etc.), sets virtual object interaction triggers and rules for how the virtual object will react and interact with other objects and surfaces, etc.

Additional details on virtual object definitions, using a manifest, invoking constructor functions, setting view states, defining virtual objects with various configurations and responses to surfaces and other objects, and combining and uncombining sets of virtual objects are provided in U.S. Pat. No. 11,176,755, issued Nov. 16, 2021, titled “Artificial Reality Augments and Surfaces,” U.S. Pat. No. 11,113,893, issued Sep. 7, 2021, titled “Artificial Reality Environment with Glints Displayed by an Extra Reality Device,” U.S. patent application Ser. No. 17/131,563, filed Dec. 22, 2020, titled “Augment Orchestration in an Artificial Reality Environment,” and U.S. patent application Ser. No. 17/511,887, filed Oct. 27, 2021, titled “Virtual Object Structures and Interrelationships,” each of which is hereby incorporated by reference in its entirety.

Implementations automatically recognize objects in an image and generate a digital item that includes a non-fungible token (“NFT”) for exportation to one or more digital environments. For example, a digital item manager can receive an image that includes several objects. One or more models (e.g., trained machine learning models) can automatically recognize the objects within the image and/or detect characteristics for the recognized objects. According to a user selection of at least one of the recognized objects, the digital item manager can generate a digital item and an NFT that supports transactions for the digital item. For example, configuration data about the user selection objects can be received, and one or more digital items and NFTs can be generated according to the configuration data. In some implementations, the digital item can include the NFT and a data file that represents the visual characteristics of the digital item.

The digital item manager can also receive a selection for one or more digital environments. For example, the digital environments can be software applications, artificial reality environments, or other suitable digital environments in which the digital items can be displayed/represented. Each digital environment can include a style protocol that establishes how digital items should be defined so that that can be displayed in the digital environment. The digital item manager can adapt a digital item into one or more versions of the digital item that comply with the style protocol(s) of the one or more digital environments. The digital item manger can then export each version of the digital item to the digital environment that corresponds to the version. In some implementations, the digital item manager can generate an NFT for each version of the digital item prior to exporting the digital item(s) to their corresponding digital environments.

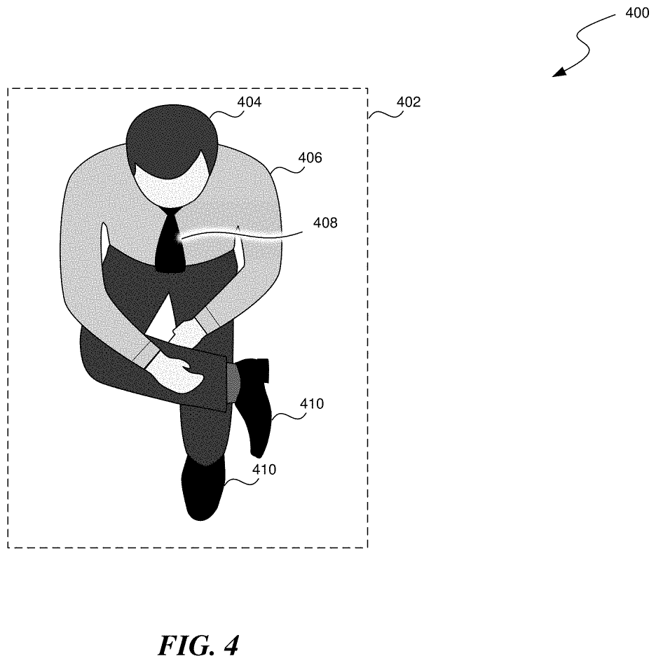

Implementations can generate digital items supported by NFTs from objects contained in an image. FIG. 4 illustrates a diagram of an example image with multiple objects. Diagram 400 includes image 402 and objects 404, 406, 408, and 410. For example, image 402 includes object 404, a person, object 406, a button-down dress shirt, object 408, a tie, and object 410, shoes. Any other suitable objects can be similarly included in image 402. In some implementations, one or more additional images can be received by the digital item manager (e.g., images from different perspectives) that includes one or more of objects 404, 406, 408, and 410.

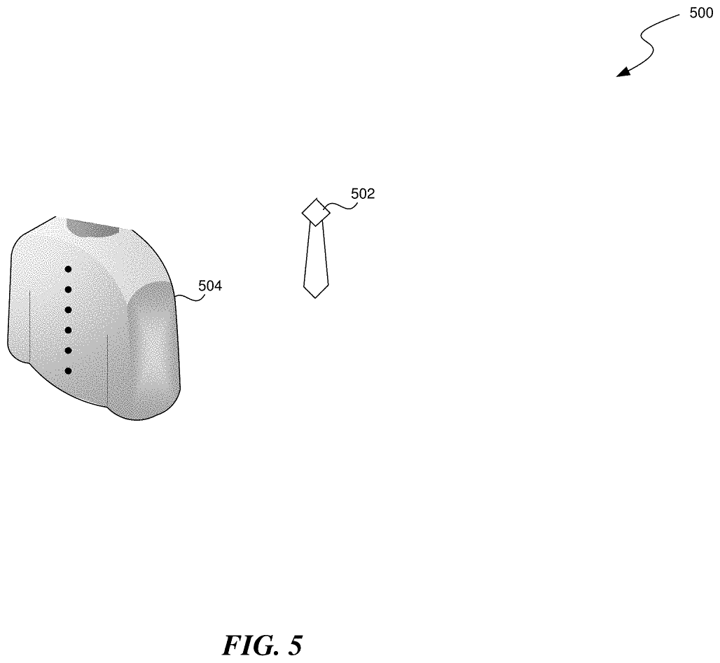

The digital item manager can use one or more machine learning models to automatically recognize the objects in image 402. FIG. 5 depicts a diagram of example objects recognized in an image. Diagram 500 includes recognized objects 502 and 504. For example, recognized object 502 includes a tie (object 408 of FIG. 4) and recognized object 504 includes a button-down dress shirt (object 406 of FIG. 4). The digital item manager can receive a selection of one or more of the objects. For example, the recognized objects 502 and 504 can be presented to a user in a user interface, and the user can select one or more of the objects via the user interface.

In some implementations, characteristics for each object can be automatically detected, such as object shape or dimensions (e.g., two-dimensional or three-dimensional mapping), color(s), size, category (e.g., t-shirt, pants, shoes, tie, person, chair, sofa, television, etc.), and the like. For example, the characteristics can be detected for each recognized object or the characteristics can be detected for each selected object. In some implementations, the objects can be displayed to the user via the user interface by displaying the image in which the objects were detected along with outlines around the detected objects. In another implementation, the objects can be displayed to the user as two-dimensional or three-dimensional representation translated according to the detected characteristics.

Referring to FIG. 5, object 504 can be a three-dimensional representation of object 406 of FIG. 4. For example, the digital item manager can generate contour models, wireframe models, or other suitable three-dimensional model/data representation for object 406. In some implementations, the digital item manager can generate the three-dimensional representation using multiple images of object 406 from multiple perspectives. In another example, one or more contour estimation techniques can be implemented to generate the three-dimensional representation.

In some implementations, configuration data can be received from the user via a user interface for the selected objects/digital items. For example, the digital item manager can be configured to generate digital items according to the selected objects and the configuration data received. In some implementations, the digital item manager is configured to generate multiple digital items using a single selected object, where the multiple digital items can be copies and/or include variations. For example, the received configuration data can include colors, sizes, numbers, and other suitable configurations for the digital items. An example set of configuration data for a shirt object can include: 10 red shorts; 10 blue shirts; and 5 green shirts. In this example, 25 digital items can be defined that correspond to the received configuration data. Any other suitable configuration data for any suitable object can be implemented.

In some implementations, the received configuration data can include selection of one or more predetermined styles. For example, a style library can include predetermined styles that correspond to predetermined configuration data, such as sizes, color ranges, resolutions, and other suitable configuration data. The user can select a predetermined style and alter the visual appearance of the digital item(s) being defined. In some implementations, while the user selects/inputs different configurations, a visual representation of the digital item(s) according to the current selected configurations can be displayed to the user. Once the user is satisfied, the user can accept the configurations and the configuration data for the digital item(s) can be generated.

In some implementations, the digital item manager can receive a selection of digital environments for the generated digital item(s). For example, digital environments can include software applications (e.g., artificial reality environments, social networks, and other suitable software ecosystems) in which a digital item can be represented (e.g., as a virtual object). Different digital environments can include different style protocols. For example, a given style protocol can establish data parameters for defining digital items in a given digital environment. A style protocol can include criteria such as a size for the digital item (e.g., file size and/or pixel size, such as 16×16, 24×24, 256×256 and the like), shape representation (e.g., 2-dimensional shape, 3-dimensional shape), a color format, a resolution (e.g., resolution range), and other suitable criteria.

In some implementations, the digital item manager can generate digital items according to the selected object(s) and received configuration data. For example, the generated digital item can include a data file that represents the visual representation of the digital item. In some implementations, the generated digital item can be a first version that includes a first version of the data file. The first version can be a default version, a version that supports universal compatibility and/or adaptability, a highest quality and/or resolution version, or any other suitable version.

After the digital item manager receives the selections for the digital environments and generates the first version of the digital item(s), the digital item manager can adapt the first version of the digital item(s) according to the style protocols of the selected digital environment. For example, a first digital environment can include a style protocol that establishes a first size criteria, first resolution criteria, and first color format while a second digital environment can include a second style protocol that establishes a second size criteria, second resolution criteria, and second color format. The digital item manager can adapt the first version of a digital item to generate a first adapted version of the digital item to comply with the first size criteria, first resolution criteria, and first color format, and a second adapted version of the digital item to comply with the second size criteria, second resolution criteria, and second color format. In some implementations, adapting the first version of the digital item can include altering a size of the digital item (e.g., enlarging or shrinking), altering a resolution of the digital item (e.g., downscaling or upscaling), translating a first color representation (e.g., according to a number, alphanumeric, or other color scale) to a second color representation, translating a first data file format into a second data file format, and other suitable adaptations.

The digital item manager can then generate NFT(s) for the digital item(s) and export the digital item(s) to the selected digital environments. For example, an NFT can be generated (e.g., minted) according to any suitable NFT protocol (e.g., Ethereum request for Comments (“ERC”)—20, ERC—721, ERC—1155, protocols for other suitable blockchain implementations, etc.). The NFT and corresponding NFT protocol can include an application programming interface (“API”) for performing transactions for the digital item. The NFT can include a unique identifier for the digital item and an association (e.g., web link) with the data file that corresponds to the digital item. The NFT protocol can include a set of smart contracts for performing transactions for (e.g., changing ownership of) the digital item. The transactions and ownership of the digital item can be maintained on a blockchain ledger according to the NFT protocol. In some implementations, an NFT protocol that supports “semi-fungible” tokens can be implemented, and multiple copies of a digital item can be generated. In some implementations, the NFT(s) for each digital item can be generated according to the NFT protocol(s) that correspond to each selected digital environment. For example, where a first adapted version and a second adapted version of a given digital item are generated for a first digital environment and a second digital environment, respectively, the digital item manager can generate an NFT for the first adapted version according to the NFT protocol implemented by the first digital environment and generate an NFT for the second adapted version according to the NFT protocol implemented by the second digital environment.

In some implementations, a given digital environment can receive the version(s) of the digital item(s) that: have been adapted according to the style protocol for the given digital environment; and include NFT(s) generated according to the NFT protocol implemented by the given digital environment. The digital item manager can export the digital item(s) using APIs provided by each digital environment.

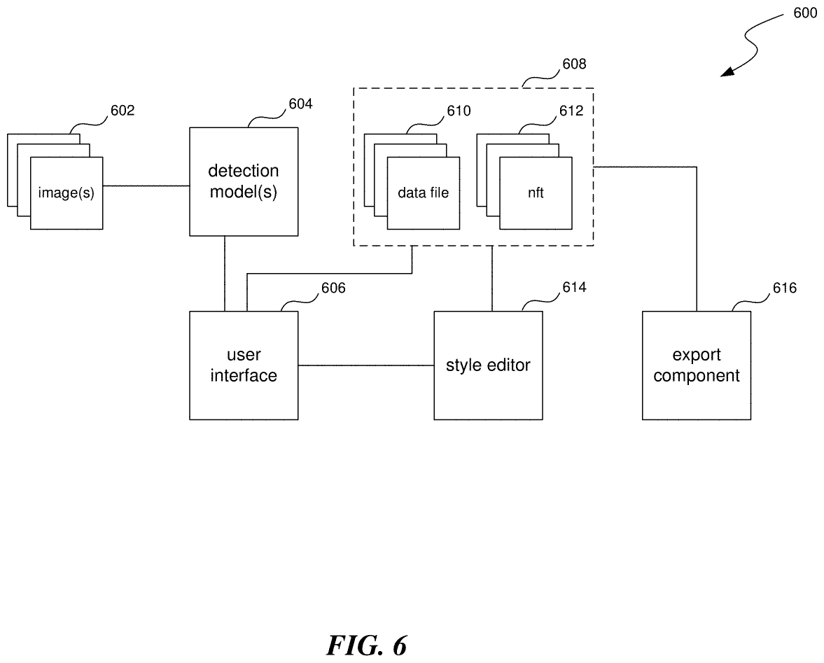

FIG. 6 depicts a system diagram of example components that generate and export non-fungible tokens using object recognition. System 600 includes images 602, detection model(s) 604, user interface 606, digital item(s) 608, data file(s) 610, NFT(s) 612, editor 614, and export component 616. For example, detection model(s) 604 can process images 602 to recognize one or more objects in the images. Detection model(s) 604 can include machine learning models trained for objects recognition and/or object characteristic detection. For example, the machine learning models can include neural networks and/or deep learning networks, such as convolutional neural networks, regional convolutional neural networks, transformer block architectures, encoder/decoder architectures, and any other suitable machine learning component.

In some implementations, the objects detected by detection model(s) 604 can be displayed to a user via user interface 606. For example, one or more of images 602 can be displayed with masks/outlines that highlight the detected objects within the image. A user can select one or more of the highlighted objects. In another implementation, user interface 606 can display a visual representation of a digital item translated using the detected characteristics for objects. For example, automatically detected characteristics for each object can include object shape or dimensions (e.g., two-dimensional or three-dimensional mapping), color(s), size, category (e.g., t-shirt, pants, shoes, tie, person, chair, sofa, television, etc.), and the like. User interface 606 can display a visual representation of the detected object for selection by the user.

In some implementations, configuration data can be received for a selected object. For example, multiple digital items can be generated using a single selected object, where the multiple digital items can be copies and/or include variations. For example, the received configuration data can include colors, sizes, numbers, and other suitable configurations for the digital items. The received configuration data can provide definitions for multiple digital items based on a selected object.

A user can also select one or more digital environments for the selected objects/configured digital items. Each digital environment can be associated with a style protocol. A style protocol can include criteria such as a size criteria for digital items, a shape criteria, a color format criteria, a resolution criteria, and other suitable criteria. In some implementations, the selected digital environments have style protocols that differ.

In some implementations, the digital items (defined according to the detected characteristics of the selected object and/or the received configuration data) can be generated. For example, a generated digital item can include a data file that stores a visual representation of the digital item (e.g., data that reflects the display characteristics of the digital item). One or more generative machine learning models can be used to generate the data file/representation of the digital item according to the digital item definitions. For example, the generative machine learning models can be trained to generate data files that power the display of digital items within digital environments. Example generative machine learning models include generative adversarial networks, encoder/decoder architectures, and other suitable machine learning models.

Editor 614 can adapt the generated digital items according to the style protocols for the selected digital environments. For example, one or more models (e.g., machine learning models) can be configured to adjust characteristics of the data file that defines the visual representation of the digital items. For example, the model(s) can be trained or configured to alter a size of a digital item (e.g., enlarging or shrinking), alter a resolution of a digital item (e.g., downscaling or upscaling), translate a first shape representation to a second shape representation (e.g., three-dimensional to two-dimensional), translate a first color representation to a second color representation, translate a first data file format into a second data file format, and other suitable adaptations. In some implementations, adapting a three-dimensional representation to a two-dimensional representation of a digital item can include selecting (by the user) a view/perspective of the three-dimensional representation and/or generating an animation for the visual representation of the digital item. Adapting a version of a digital item to meet a style protocol can include any other suitable user input for altering the version of the digital item.

In some implementations, while generating a given digital item one or more versions of the digital item can be generated, such as versions with different sizes, resolutions, shape models/dimensions, color formatting, and the like. For example, a first generative model can be configured to generate a first version of the digital item and a second generative model can be configured to generate a second version of the digital item. In another example, a single generative model may generate multiple versions of the digital item. The multiple versions of a given digital item can be used to meet the differing style protocols for the select digital environments. In some implementations, when the multiple versions of the digital item do not meet a style protocol for a selected digital environment, editor 614 can adapt one of the versions to generate an adapted version that meets the style protocol.

In some implementations, prior to exporting the digital item(s) to the selected digital environments, NFTs 612 can be generated for the digital item(s) (e.g., for each version of the digital item(s) adapted for exportation to a digital environment). NFTs 612 support transactions for the digital item(s) using a blockchain ledger. For example, ownership of a digital item can be changed using transactions performed by one or more smart contracts associated with NFTs 612. An NFT 612 can be used to validate ownership of a digital item, for example using an API associated with an NFT protocol. In some implementations, NFTs 612 can be generated according to NFT protocols implemented at the selected digital environments. The NFTs 612 can have links to the stored location of the digital items, what items the NFTs supply ownership of.

Export component 616 can export version(s) of a given digital item to the corresponding digital environments. In an example, each version of the given digital item can be adapted according to a specific style protocol, and the digital environments associated with each specific style protocol can receive the version of the digital item adapted for the specific style protocols. In another example, multiple versions of the digital items can be generated, and the digital environments can each receive a version that meets the style protocol for the digital environment. In some implementations, the user can be displayed the version(s) of the digital item via user interface 606, and user approval can be received prior to exportation.

Within the digital environments, the digital items can be displayed and/or transactions can be performed for the digital items. For example, display can include displaying a two-dimensional representation of the digital item on a user's social media presence. In another example, display can include displaying a virtual object that corresponds to the digital item in a three-dimensional artificial reality. In some implementations, users can interact with the virtual object display of a digital item in a digital environment. For example, the digital environment can be an artificial reality implemented by an artificial reality system. A user, avatar, or representation of the user in the digital environment can wear a virtual clothing item, drive a virtual car, and the like. In another example, the user can sell the digital item according to smart contracts and the NFT digital ledger.

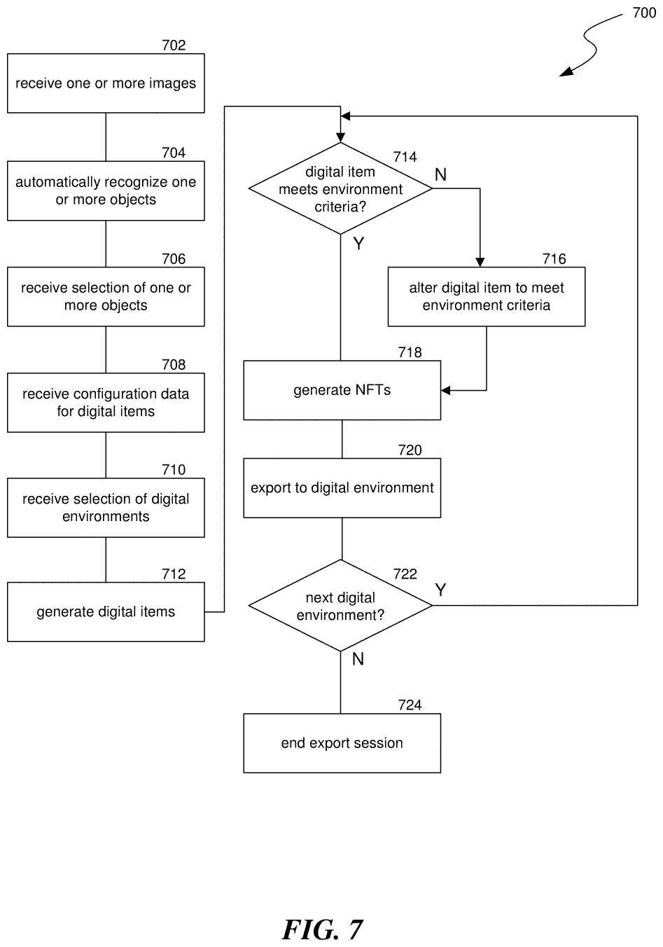

FIG. 7 is a flow diagram illustrating a process 700 used in some implementations for generating and exporting non-fungible tokens using object recognition. In some implementations, process 700 can be triggered by a user or by receiving one or more images from a user. Implementations of process 700 generate digital items that can be exported to various digital environments.

At block 702, process 700 can receive one or more images. For example, an image depicting one or more objects (e.g., real-world objects) can be received. In some implementations, multiple images depicting multiple objects can be received. In some implementations, multiple images depicting different perspectives of a same object can be received.

At block 704, process 700 can automatically recognize one or more objects within the one or more images. For example, the objects can be recognized using machine learning model(s) configured/trained for object recognition within images. In some implementations, characteristics for each object can be automatically detected, such as object shape or dimensions (e.g., two-dimensional or three-dimensional mapping), color(s), size, category (e.g., t-shirt, pants, shoes, tie, person, chair, sofa, television, etc.), and the like.

At block 706, process 700 can receive a selection for at least one of the recognized objects. For example, a user can select an object using a display of the image within which the object was recognized and/or using a visual representation (e.g., two-dimensional or three-dimensional representation) of the object recognized in the image.

At block 708, process 700 can receive configuration data for digital item(s). For example, one or more digital item(s) can be generated according to a selected object. In some implementations, multiple digital items can be generated according to a single selected object, where the multiple digital items can be copies and/or include variations. For example, the configuration data can include colors, sizes, numbers, and other suitable configurations for the digital items. An example set of configuration data for a selected shirt object can include: 5, red, in each of child and adult sizes; 5, blue, in each of child and adult sizes; and 5 green, in each of child and adult sizes. In this example, 30 digital items can be defined that correspond to the received configuration data and a single selected object. Any other suitable configuration data for any suitable object can be implemented.

At block 710, process 700 can receive a selection of one or more digital environments for the digital item(s). For example, digital environments can include software applications (e.g., artificial reality environments, social networks, and other suitable software ecosystems) in which the digital item(s) can be represented (e.g., as a virtual object). Different digital environments can include different style protocols. For example, the style protocol for a social network application that displays digital items as two-dimensional images can be different from the style protocol for an artificial reality environment that displays digital items as three-dimensional virtual objects. In addition, among artificial reality environments, style protocols can differ by resolution criteria, shape criteria, size criteria, color formatting, and other suitable differences.

At block 712, process 700 can generate digital item(s) according to the selected object and configuration data. For example, each generated digital item can include a data representation of the digital item (e.g., data file). In some implementations, the generated digital item(s) can be first version(s) that include a first version of the data files. The first version(s) can be default versions, versions that supports universal compatibility and/or adaptability, or any other suitable versions. The data representation of the digital item(s) (e.g., data file) can be generated by a generative model (e.g., generative machine learning model) that takes as input the selected object (e.g., detected object characteristics) and the configuration data, and outputs one or more data representations of the digital item.

At block 714, process 700 can determine whether the digital item(s) meet a style protocol for the digital environment. For example, the first version(s) of the digital item(s) can be compared to the style protocol for a current digital environment (e.g., a first of the selected digital environments). In some implementations, the comparison can include comparing the data representation (e.g., data file) for the first version(s) of the digital item(s) to the criteria for the style protocol. In some implementations, the comparison can include comparing the data representation (e.g., data file) for any stored version(s) of the digital item(s) to the criteria for the style protocol. For example, multiple versions of the digital item(s) can be generated and/or an altered version of the digital item(s) may have been previously generated and stored. When a stored version of the digital item(s) meets the style protocol, process 700 can progress to block 718. When a stored version of the digital item(s) does not meet the style protocol, process 700 can progress to block 716.

At block 716, process 700 can alter the digital item(s) according to a style protocol for the current digital environment. For example, a stored version(s) of the digital item(s) can be adapted to generate an adapted version of the digital item(s) that complies with the style protocol for the current digital environment. In some implementations, adapting the digital item(s) can include altering a size of the digital item(s) (e.g., enlarging or shrinking), altering a resolution of the digital item(s) (e.g., downscaling or upscaling), translating a first color representation (e.g., according to a number, alphanumeric, or other color scale) to a second color representation, translating a first data file format into a second data file format, and other suitable adaptations.

At block 718, process 700 can generate NFT(s) for the digital item(s). For example, an NFT for each digital item can be generated (e.g., minted) according to the NFT protocol(s) that correspond to the current digital environment. The NFT can include a unique identifier for the digital item and an association (e.g., web link) with the data file that corresponds to the digital item. The NFT(s) for the digital item(s) can support transactions for the digital item(s) using a blockchain ledger (e.g., after exportation to the digital environment).

At block 720, process 700 can export the digital item(s) to the digital environment. For example, the current digital environment can receive version(s) of the digital item(s) that have been adapted according to the style protocol for the current digital environment. In another example, the current digital environment can receive stored version(s) of the digital item(s) that comply with the style protocol for the current digital environment. In some implementations, the digital item(s) can be exported using APIs provided by each digital environment.

At block 722, process 700 can determine whether a next digital environment is available. For example, blocks 714-422 can be performed for each digital environment selected at block 710. When a next digital environment is available, process 700 can loop back to block 714, where process 700 can determine whether the digital item(s) meet an environment criteria for the next digital environment. When a next digital environment is not available, process 700 can progress to block 724. At block 724, process 700 can terminate the export session for the digital item(s).

A product recommendation system (hereinafter “recommendation system”) can generate recommendations for one or more products and provide those recommendations in real time. Herein, the term “product” can include, for example, an item to be purchased, a movie or video selection, a restaurant selection, an action to be taken in a social media environment, a virtual object in an AR/VR environment, etc. In various implementations, the recommendations can be made using a current context of user activities (e.g., shopping, browsing online, engaging in an AR/VR environment, interacting on social media, etc.) That is, the current context can be matched to known products which may be available for the context. In these regards, the term “context” can define, for example, one or more of a location, a time, a season of the year, a type of purchase, etc. for a user activity. In various implementations, one or more recommendations including the matched products can be expanded using contextual comparisons for activities of the user and those of other users. For example, if the context is “Christmas,” the recommendation system can recommend products not only according to the matching for the user but also according to those products satisfying a threshold level of contextual matching for prior activities of other users.

The recommendation system can generalize each of the user activities according to their respective topics and associated contexts. This way, as the user activities are processed by the recommendation system, their specific details are shielded from potential inadvertent disclosure to ensure maintaining a user's privacy.

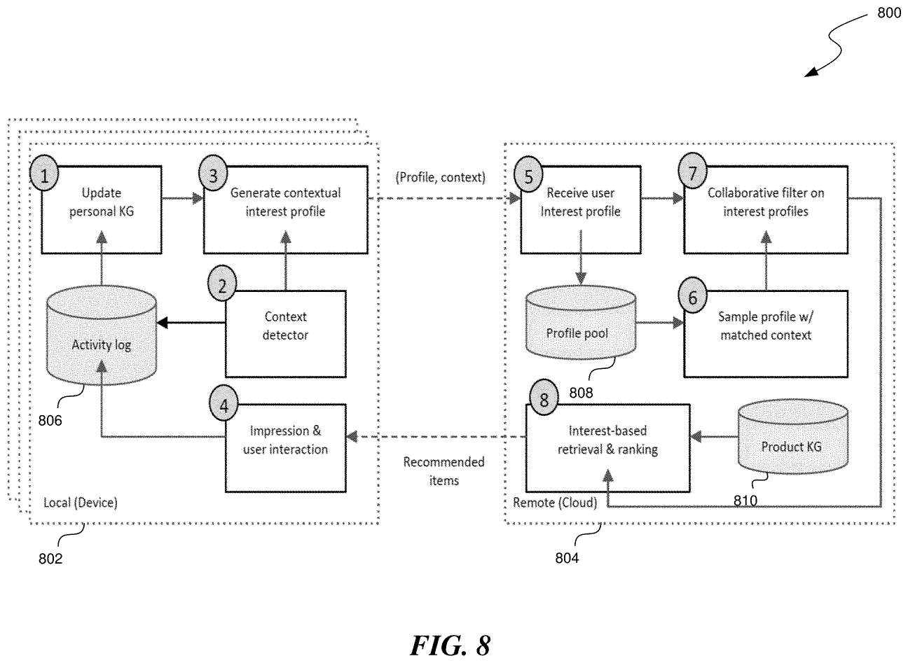

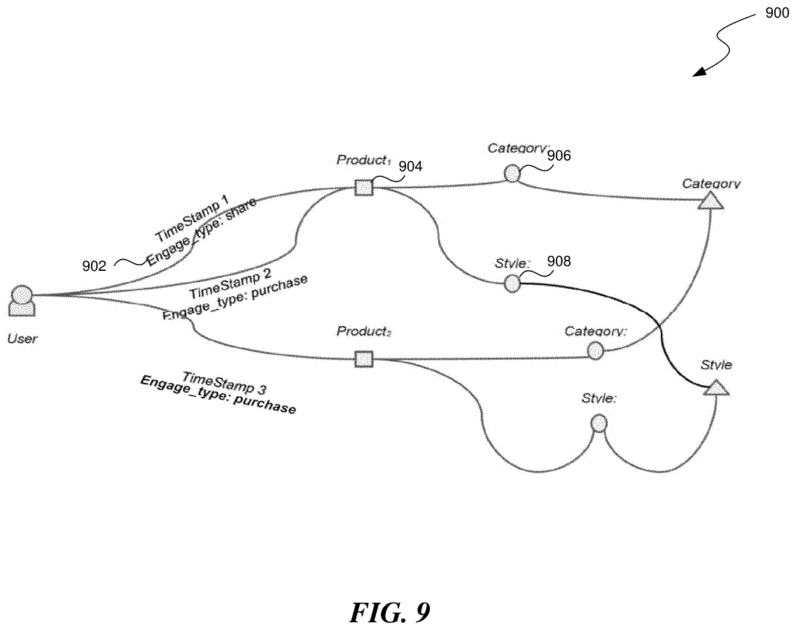

FIG. 8 is an example architecture for a recommendation system 800 that can generate and provide product recommendations to a user. The recommendations system 800 can include a local subsystem 802 that can run on a user's local device (e.g., AR/VR device, smartphone, etc.) and a remote subsystem 804 that can run on a remote server (e.g., cloud system or data center). As shown, the local subsystem 802 can execute the following functionality, including (1) capturing the user's recent activities for a given context from the indicated Activity log 806 so as to update a personal knowledge graph (KG) for the user (see FIG. 9 and accompanying discussion), (2) detecting the current context for the user's activities using, for example, sensory devices defined by the local device, (3) generating a contextual user interest profile representing the user's current preference with respect to an activity, and (4) receiving recommendations, i.e., delivering, a recommendation according to operation of the recommendation system 800 and logging user views (“impressions”) and user interactions with those recommended items to further update the personal KG. The remote subsystem 804 can be a cloud-based system or data system operated by a social media outlet. That remote subsystem 804 can execute the following functionality, including (5) receiving the contextual user interest profile from the local subsystem, (6) identify anonymous profiles, contained in the indicated Profile pool 808, that specify a context best matching a context of the received user interest profile, (7) creating an expanded interest profile with a combination of the identified anonymous profiles and the received profile, thereby expanding the scope of products that can be recommended for the context of the received profile, and (8) generating a product recommendation for the expanded interest profile by querying a product KG 810 defining a set of potential products that can be recommended.

FIG. 9 is an example of a type of personal knowledge graph (KG) that can, in some implementations, demonstrate user activities under certain contexts. Therein, recommendation system can use entries in an Activity log to construct a history of engagements 902, i.e., activities, of a user for respective contexts. That is, the constructed history can reflect user activities for one or more products 904 (e.g., a movie selection, a video selection, a restaurant selection, etc.) and their corresponding contexts. For those products and contexts, the history can indicate corresponding topics, such as categories 906 and styles 908, etc. for the engaged products. When reading Table 1 below and FIG. 9 together, it can be understood that the recommendation system can track a user's activities and their corresponding contexts so that a contextual user interest profile can be constructed. In this regard, the constructed profile can be limited to define topics for the activities accompanied by appropriate contextual signals indicating a current context for the activities.

TABLE 1

| timestamp | product | engagement | Context signals |
|---|---|---|---|
| 2021 Nov. 25 | (id: XXX, artifact | {type: | {location: XXXX, scene: indoor, |
| 13:00:00 | {color: red, | purchase, | speed: walking, . . . } |
| | category: fashion, | weight: $100} | |
| | style: sport, . . . } | | |
| 2021 Nov. 25 | (id: XXX artifact | {type: skip, | {location: XXXX, scene: indoor, |
| 13:14:00 | {color: blue, | weight: 0} | speed: walking, . . . } |
| | category: mobile, | | |
| | style: foldable, . . . } | | |
| 2021 Nov. 25 | (id:XXX, artifact | {type: like, | {location: XXXX, scene: indoor, |
| 19:30:00 | {color: n/a_{;} | weight: 5 stars) | speed: sitting, . . . } |
| | category: video, | | |
| | style: funny, . . . } | | |

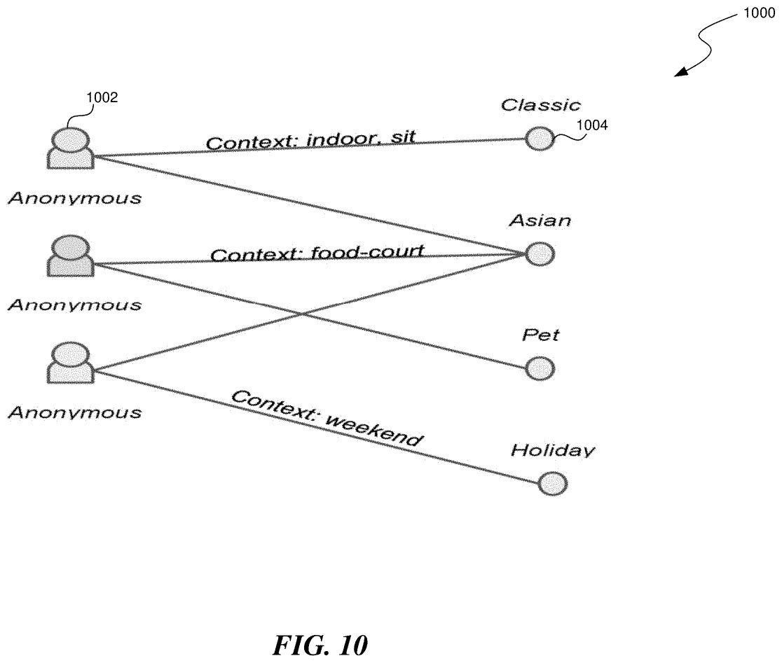

FIG. 10 is an example of a type of profile pool of anonymous user profiles302 that can, in some implementations, demonstrate corresponding topics of user interest 1004 for corresponding contexts. Diagrammatically, each user profile 1002 on the left is connected by a line defining a context in which a respective user profile 1002 is connected, i.e., associated, to a topic of interest 1004 on the right. Here, each profile can define a set of weighted topics derived from a given taxonomy (i.e., a set of concepts describing a user's interests). For example, the topics 1004 shown include Classic, Asian, Pet, and Holiday.

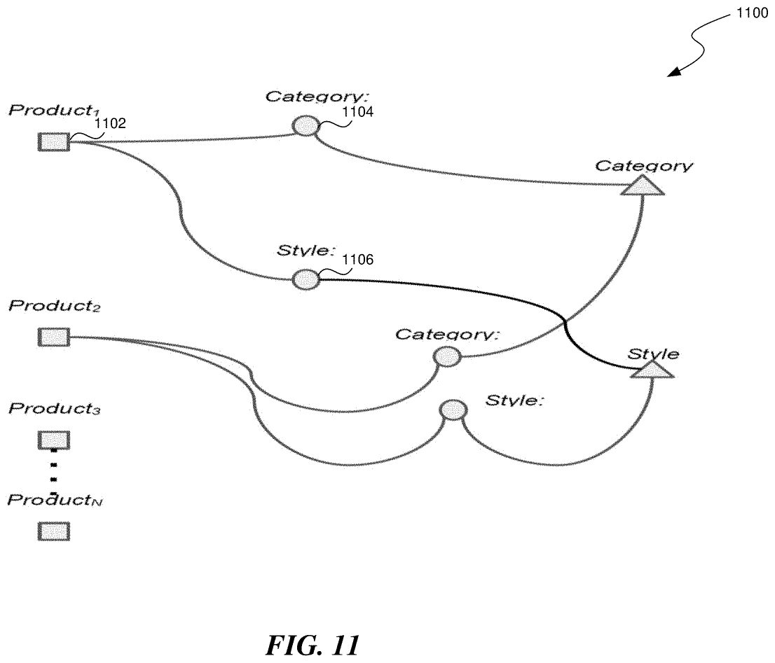

FIG. 11 is an example of a type of product knowledge graph (KG) that can, in some implementations, demonstrate products 1102 that the product recommendation system can recommend to a user. More specifically, the included products 1102 can be characterized by associated topics (e.g., category 1104, style 1106, etc.) derived from a relevant taxonomy. This way, various types of products 1102 can be represented collectively and distinguished by the recommendation system when generating a recommendation according to a given context.

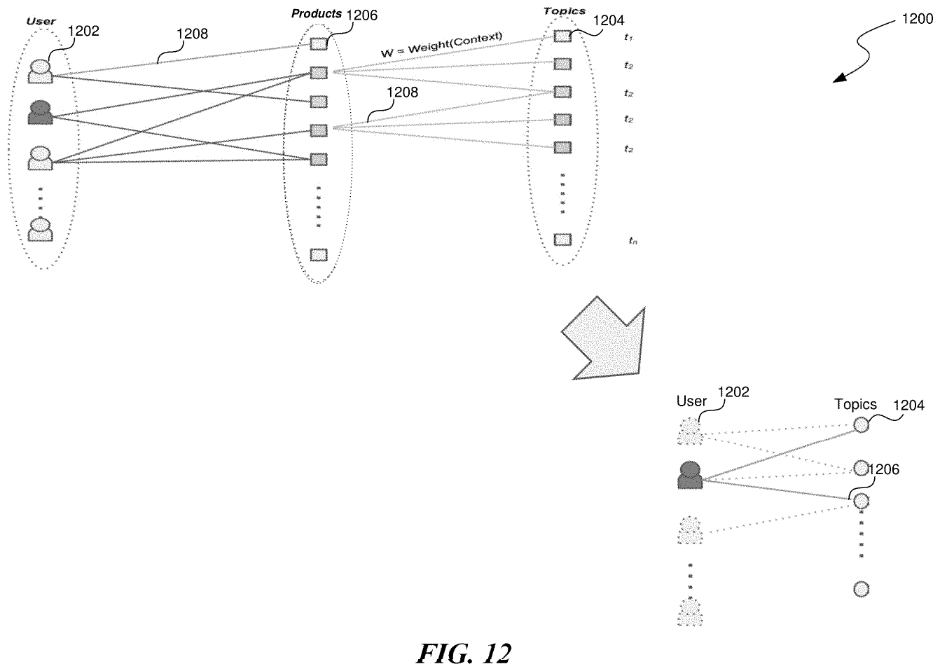

FIG. 12 is an example of a graph that can, in some implementations, demonstrate how the recommendation system defines a user profile 1202 by transforming a user's activities to corresponding topics of user interest 1204. When generating a contextual user interest profile 1202 for a user, the recommendation system can use the data stored by an Activity log to convert user activities to generalized topics 1204. This way, a user's specific activities remain shielded from being transmitted to a remote subsystem, thus maintaining the user's privacy. As shown in FIG. 12, the recommendation system can extract from those activities for profiles corresponding products 1206 and contexts 1208. Once extracted, the products 1206 can be related to corresponding generalized topics 1204 (using a taxonomy defined by, for example, products from product KG which were included in prior recommendations). Edges of the topic nodes 1204 can be differently weighted and can reflect a corresponding context 1208 including, for example, recency of an activity, repetition for an activity, etc.

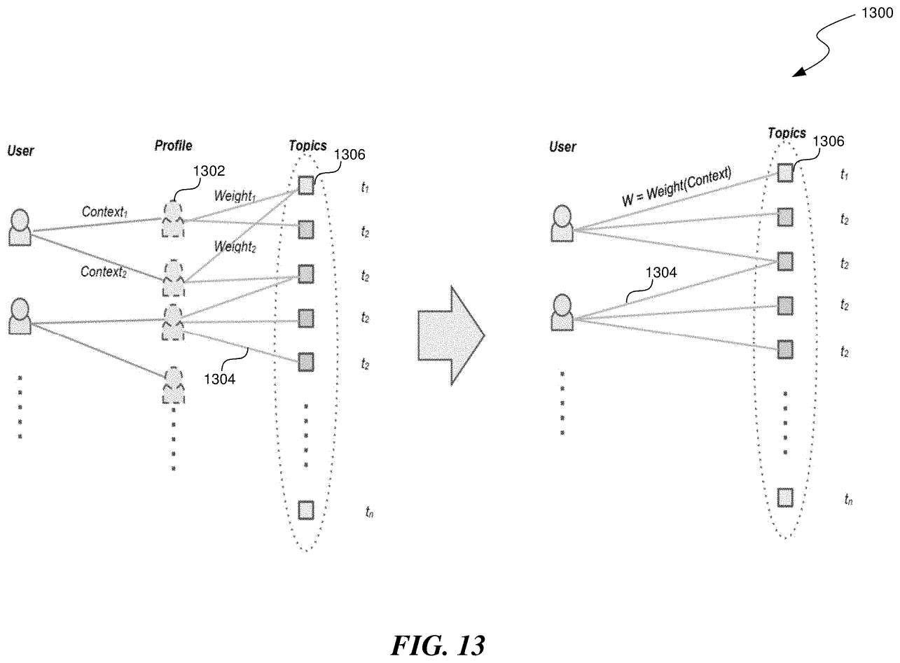

FIG. 13 is an example of a graph that can, in some implementations, demonstrate how the product recommendation system can identify multiple user profiles 1302 for a same user according to different contextual weights 1304 for corresponding topics of user interest 1306. For instance, if the topic 1306 is “movie selections,” different contextual weights can signify differences in preferences for viewing a movie during a weekday as opposed to a weekend. In this regard, a weight 1304 can be zero if a particular topic 1306 is not available for a given context.

In some implementations, the recommendation system can formulate a contextual user interest profile 1302 (defining topics of a user's interest 1306) according to a history of user activities defined by an Activity log. For example, a recently captured profile can be blended with an older one (if any) to combine both the short-term and long-term interests of a user, i.e., profile=blend_model(profile, profile_{new}), where various blending strategies can be applied. For example, a simple blending could be conducted as profile=α·profile+(1−α) profile_{new}. Similarly, if a user explicitly specifies any topics 1306 (or eliminates any), the recommendation system can simply add or remove those topics 1306 from the profile and re-normalize the weights.

As will be understood from the discussion thus far, the recommendation system can generate a proactive recommendation for one or more products corresponding to a user's current context. In doing so, the recommendation system can register a user's interactions when in a given context to assess the user's activities. Once the activities are assessed, the recommendation system can identify a current context for the activities to then generate a corresponding contextual user interest profile for the current context. For example, when a user steps into a plaza around lunch time, a context detector can trigger a profile generator. Given the context (i.e., location and time), the produced profile can indicate the user's preference on the topic of food, such as Japanese Cuisine. Once the topic is identified for the given context, the local subsystem can send it to the remote subsystem, which can then generate recommendations for restaurants (i.e., products) in that plaza that correspond to the identified preferred cuisine. Accordingly, the provided recommendation can be personalized to the user and proactive in nature.

Generating a recommendation in the above manner can sometimes be seen as limiting since it serves to reinforce prior engaged interests without offering alternatives. Accordingly, the recommendation system can augment the recommendations to be provided to a user by analyzing topics and their associated contexts that correspond to other anonymous user profiles. So that the augmenting is appropriate for the user's current context, the recommendation system can employ a “collaborative” filtering for the other profiles such that their topics and contexts are compared to the user's context to determine their degree of similarity. The recommendation system can represent each of the contexts for profiles as a sparse vector which can be fed to an autoencoder, and then measure the difference between respective encodings to assess similarity. Since each profile is characterized by topics accompanied by contextual signals and derived from products for those topics, recommendation system can explore, for instance, candidate products from a product KG that can be recommended to a user.

Thus, the similarity (s) between products (pᵢ, pⱼ) can be found according to the following Equation (1):

$${s}_{{p}_{i} , {p}_{j}} = \frac{{\sum }_{u} ( {s}_{{u}_{i} {p}_{i}} \cdot {s}_{{u}_{i} {p}_{j}} )}{\sqrt{{\sum }_{u} {s}_{{u}_{i} {p}_{i}}^{2} {\sum }_{u} {s}_{{u}_{i} {p}_{j}}^{2}}} = \frac{{\sum }_{u} ( ( {\sum }_{k} {s}_{{u}_{i} {t}_{k}} {s}_{{t}_{{k}_{i} {p}_{i}}} ) \cdot ( {\sum }_{k} {s}_{{u}_{i} {t}_{k}} {s}_{{t}_{{k}_{i} {p}_{j}}} ) )}{\sqrt{{\sum }_{u} {( {\sum }_{k} {s}_{{u}_{i} {t}_{k}} {s}_{{t}_{{k}_{i} {p}_{i}}} )}^{2} {\sum }_{u} {( {\sum }_{k} {s}_{{u}_{i} {p}_{j}} {s}_{{u}_{i} {p}_{j}} )}^{2}}}$$

Therein, pᵢ represents a respective one or more of products of recommendation P={p₁, p₂, . . . , pₙ} that, for the received contextual user interest profile, the recommendation system had selected according to matching of products included in product KG. Also, pⱼ represents a product that is similar to, but not the same as, pᵢ.

Accordingly, the recommendation system can conduct the collaborative filtering to determine, based on the anonymous profiles being examined and their corresponding matching products, others of products that can be added to pᵢ to expand the scope of product recommendations that can be provided to a user. In this regard and according to the above collaborative filtering, for each product found as pᵢ, the recommendation system can discern similar products from the product KG; that is, given pᵢ ∈P, and finding a product pⱼ∉P but similar to pᵢ, the recommendation system can augment P by adding pⱼ. In this way, the recommendation system can provide an augmented recommendation for the user's current context of activities as P=pᵢ+pⱼ.

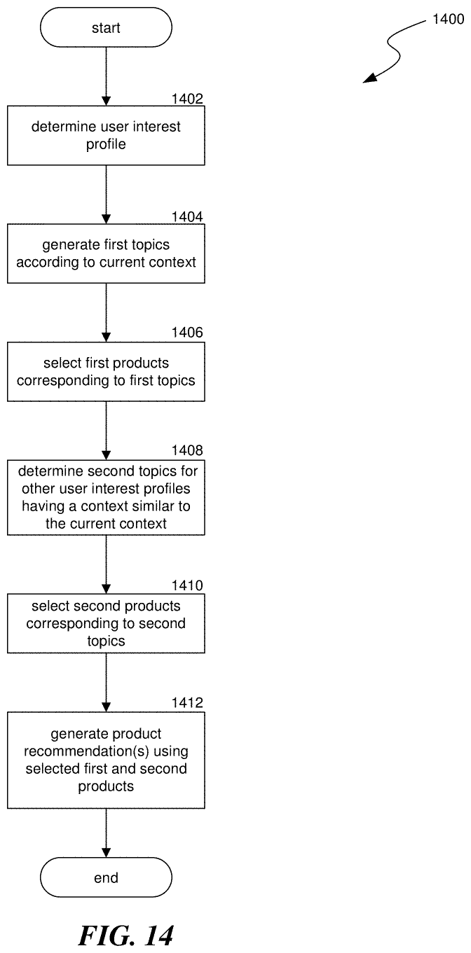

FIG. 14 is a flow diagram illustrating a process 1400 used in some implementations for generating one or more product recommendations to be provided to a user for a current context of the user's activities. In some implementations, process 1400 can be performed according to communication between a local device, e.g., a smartphone or AR/VR device, and a remote system such a cloud based operating system or data center of a social media outlet. In these regards, actions for blocks 1402 and 1404 discussed below can be performed on the local device, and actions for blocks 1406-1412 can be performed on the remote system.

At block 1402, process 1400 can determine a contextual user interest profile of a user. The profile can be derived from activities engaged in by the user when using a local device such as a smartphone, smart glasses, or an AR/VR headset. The activities can be stored on the portable device in an appropriate storage thereof (e.g., Activity log of FIG. 8).

At block 1404, process 1400 can, using the stored activities, generate one or more first topics for a current context (e.g., location and time). That is, the stored activities can reflect a user's interest in certain products from which the topics can be derived. In some implementations, the one or more first topics can reflect a user's interest across multiple timeframes according to activities for products in regard to those timeframes.

At block 1406, process 1400 can select first products that correspond to the first topics for the current context. Process 1400 can make one or more selections by determining that products included within product KG are a match for relevant topics and their corresponding contexts. For instance, if the topic is Japanese cuisine in the context of being present in a plaza at noon, then process 1400 can select those establishments that may be located in the plaza and open for business on the day that the presence is detected.

At block 1408, process 1400 can determine second topics corresponding to the first topics from other user profiles (from within a Profile pool) that have a context that is similar to that of the user interest profile. As already discussed, the similarity in contexts can be measured according to a distance between vectors representing the contexts. Thus, the contexts for second topics can be said to be similar if the distance is less than a threshold distance.

At block 1410, process 1400 can select second products corresponding to the second topics according to Equation (1) above. This way, process 1400 can augment the recommendation options to include these second products, i.e., products that can be matched to the first products according to a similarity between the first and second topics and their corresponding contexts.

At block 1412, process 1400 can generate a product recommendation, including the first and second products, that process 1400 can cause to be transmitted to the user.

When implementing process 1400, recommendation system 1400 can be implemented to incur lightweight processing at the local subsystem. This is the case as the complexity of a recommendation can be defined by the number of products included in a received recommendation (e.g., a few dozen) multiplied by their corresponding topics. That is, since the number of products is not excessive, capacity and power demands are not burdensome. Further, such a lightweight degree of processing is further attributable to straightforward (e.g., single-pass) filtering when generating a contextual user interest profile from a personal KG.

An NFT content placement system can augment a digital environment (e.g., a photograph, a video frame, etc.) with NFT content corresponding to an NFT wallet of a user. In some implementations, the digital environment can represent one or more real-world or AR/VR settings, and the NFT content can represent, for example, digital art or other types of NFT items owned by the user. The NFT content placement system can connect with the NFT wallet of the user to enable the importation of one or more NFT items into the digital environment. Once imported, the NFT content placement system can, for the digital environment, allow user selection of one or more horizontal or vertical planes on which one or more NFT items can be placed. Afterward, the NFT content placement system can integrate the one or more placed NFT items into the digital environment by locking their respective placements onto the selected surface. This way, the NFT content placement system can tailor an appearance for the digital environment according to a user's specific preferences and purposes. The NFT included in the digital environment can be viewed in various platforms such as through a social media page or application, which may include additional details from the NFT such as its owner, source, or other data from the blockchain. For instance, inclusion of one or more NFT items can enable a user of the NFT content placement system to perhaps tell a story, convey a discrete sentiment or message, etc.

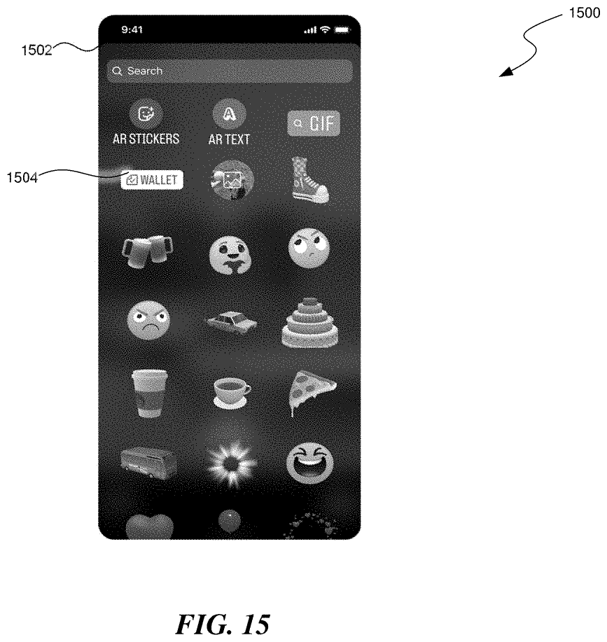

FIG. 15 illustrates an exemplary user interface 1500 of a user device (e.g., a smartphone). Through the interface 1502, a user can access her NFT wallet 1504. For example, the NFT wallet 1504 can be designated by an icon enabling access to its contents. In some implementations, the contents can represent “digital collectibles” in the form of digital art, autographs, etc., or other types of NFTs owned by the user. As discussed below, one or more digital wallets can be linked to the platform, allowing the owner to include the associated content items as NFTs in content such as social media posts, artificial reality environments, etc.

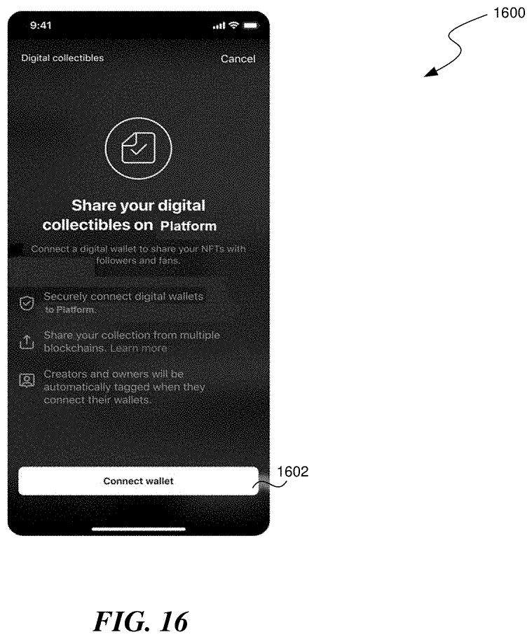

FIG. 16 illustrates an exemplary user interface 1600, for the NFT content placement system and that can, in some implementations, enable linking of an NFT wallet of a user to the NFT content placement system. Access to the NFT wallet can be through a registration process by which the wallet owner provides credentials or other access tokens, allowing the system to view the content linked in the blockchain to the NFT wallet (i.e., read the owned NFTs, determine their corresponding content storage locations, and pull the owned content items into the user interface for user selection, as shown below). As shown, a user can simply press “Connect wallet” at 1602 to link the NFT content placement system and reveal applicable blockchain addresses for corresponding NFT content owned by the user. This way, the NFT content placement system can access digital collectibles (and other types of NFT content) of the user that are stored on the given blockchain(s) so that they may be made available for importation to a digital environment of the user as virtual objects for that environment.

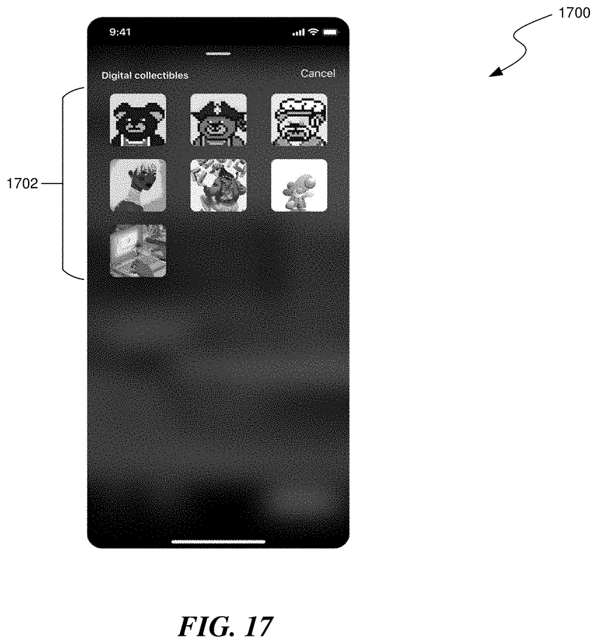

FIG. 17 is an exemplary user interface 1700, for the NFT content placement system and that can, in some implementations, enable the display and selection of one or more digital collectibles corresponding to content for an NFT wallet of a user. As shown, the digital collectibles can represent various forms of digital art 1702. However, in some implementations, such digital collectibles can represent other forms of NFTs, such as social media interactions, a digitized autograph, etc. Upon selection, the NFT content placement system can import one or more digital collectibles into a digital environment of the user (as illustrated below).

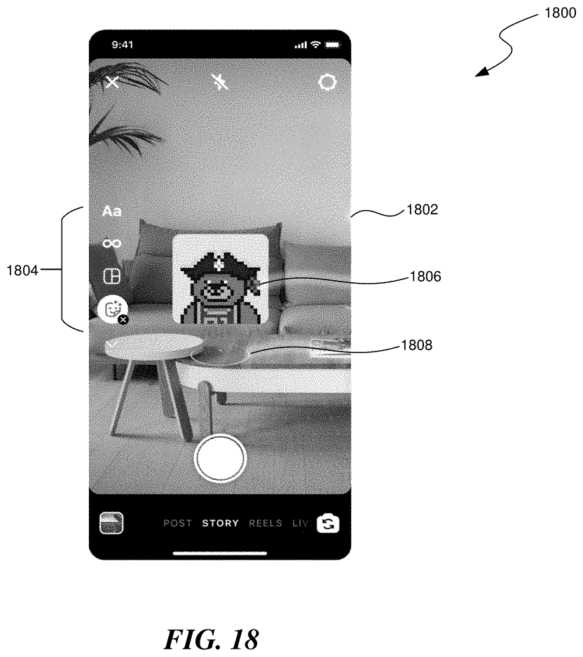

FIG. 18 is an exemplary user interface 1800, for the NFT content placement system and that can, in some implementations, enable placement of NFT content within a digital environment 1802. For example, the interface 1800 can present various controls 1804 for arranging a selected digital collectible within the environment 1802. Such controls can include shading selectors, options to add text, tagging options, or a horizontal or vertical plane identifier, which can identify surfaces shown in a content item (such as an image, video, 3D model, etc.) according to, for example, a machine learning model trained to identify planar orientation among objects for various settings. A user can then select such a surface (table surface 1808 in this instance) onto which the content item from the NFT is attached. Where the content item can change perspectives (such as in a 3D image, a video, or an artificial reality environment) the NFT content item can be adjusted to keep it's relative position to the selected surface as the viewing perspective changes. This way, a digital collectible, such as a collectible 1806, can be placed within a given digital environment according to a user's preference for conveying, for example, a desired narrative, sentiment, etc. In some cases, the NFT can be selected to view additional information such as ownership, creator, a source NFT marketplace, etc.

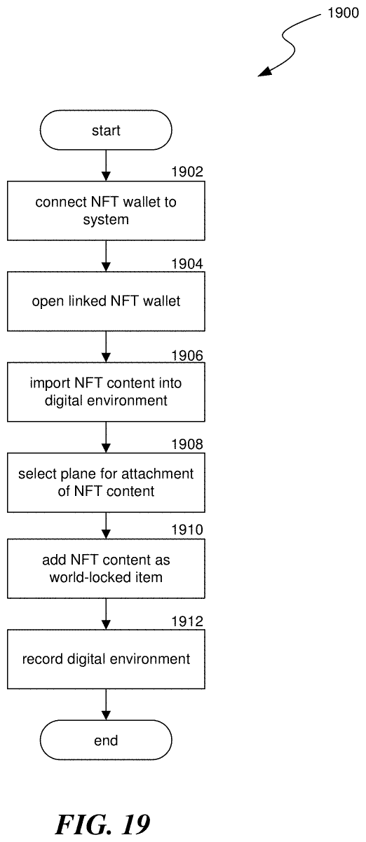

FIG. 19 is a flow diagram illustrating a process 1900 used in some implementations for placing NFT content within a digital environment. In some implementations, process 1900 can be performed on a client device—such as a mobile device executing the NFT content placement system as part of an app or on a personal computing device as client-side process of a website. In other cases, process 1900 can be performed on a server system, e.g., a system serving NFT selection and placement results via such an app or website. Process 1900 can be initiated in response to a user command, such as whenever a user of NFT content placement system desires to select and place NFT content corresponding to the user's NFT wallet in a digital environment.

At block 1902, process 1900 can connect a user's NFT wallet to the NFT content placement system which, in some implementations, can be operated on an interactive platform, e.g., a social media outlet. That is, process 1900 can access the user's device directly to obtain a connection with a stored NFT wallet. Alternatively or in addition, process 1900 can access such an NFT wallet through a portal of a platform for the NFT content placement system. For example, the user can provide credentials to access her NFT wallet, can provide an identifier for the NFT wallet with corresponding blockchain information, etc.

At block 1904, process 1900 can open content associated with the linked NFT wallet in accordance with the blockchain address accessed from the wallet. Each NFT can be generated (e.g., minted) according to any suitable NFT protocol (e.g., Ethereum request for Comments (“ERC”)—20, ERC—721, ERC—1155, protocols for other suitable blockchain implementations, etc.) The NFT protocol can include a set of smart contracts for performing transactions for (e.g., changing ownership of) the digital item. The transactions and ownership of the digital item can be maintained on a blockchain ledger according to the NFT protocol. The NFT can include a unique identifier for the digital item and an association (e.g., web link) to the data file that corresponds to the digital item.

At block 1906, process 1900 can retrieve and import the content, linked to by each NFT, into one a content item for or more digital environments (e.g., a video, a photograph, etc.) For example, process 1900 may open the link associated with each NFT and download it or a thumbnail of it to the UI for user selection. A user may then select one of the NFTs from the imported list. If the full content item linked to by the NFT has not yet been retrieved, process 1900 can do so. Process 1900 may translate whatever file format the NFT content is stored in so that it is amenable to, for example, sizing, brightness, contrast, and placement controls which are operable for the NFT content placement system. In some implementations, the NFT content can be added into a digital container or template for use with the platform or environment into which the NFT content will be shown. In some implementations, the container can include various meta-data and display options, such as showing ownership, source data, etc. from the NFT when the container (with the NFT content) is selected or viewed (e.g., on a social media platform).

At block 1908, process 1900 can identify one or more planes (horizontal or vertical surfaces), within a desired digital environment, for attachment of the imported NFT content. In doing so, process 1900 can implement a machine learning model trained to identify planar orientation among objects for various settings. The user can then select one of these planes for attachment of the imported NFT content. This way, a user of the NFT content placement system can customize placement of the imported NFT content according to one or more identified planes within the digital environment.

At block 1910, process 1900 can add the imported NFT content as a world-locked item for the digital environment. For instance, process 1900 can update horizontal, vertical, and rotational movement of the NFT content as a viewing user's perspective of the digital environment changes. For example, if the digital environment is a video, as the camera pans about, the placement of the NFT content can be updated in the video to stay consistently placed relative to the selected plane. This way, process 1900 can fix the positioning of the NFT content for the digital environment.

At block 1912, process 1900 can record the digital environment to thus capture the imported NFT content at the fixed position. In doing so, the NFT content placement system can preserve an appearance of the digital environment, which a user of the NFT content placement system can make available for others, for instance via a social media platform.

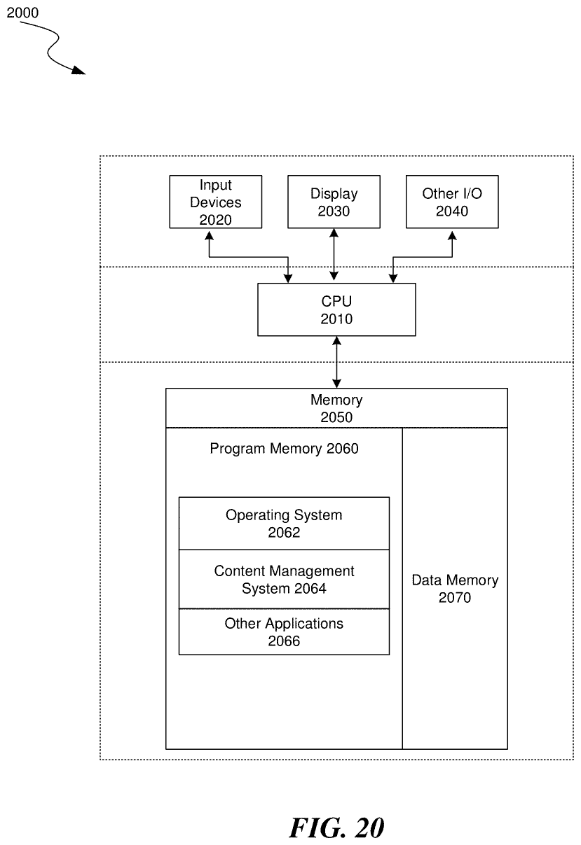

FIG. 20 is a block diagram illustrating an overview of devices on which some implementations of the disclosed technology can operate. The devices can comprise hardware components of a device 2000 as shown and described herein. Device 2000 can include one or more input devices 2020 that provide input to the Processor(s) 2010 (e.g., CPU(s), GPU(s), HPU(s), etc.), notifying it of actions. The actions can be mediated by a hardware controller that interprets the signals received from the input device and communicates the information to the processors 2010 using a communication protocol. Input devices 2020 include, for example, a mouse, a keyboard, a touchscreen, an infrared sensor, a touchpad, a wearable input device, a camera- or image-based input device, a microphone, or other user input devices.

Processors 2010 can be a single processing unit or multiple processing units in a device or distributed across multiple devices. Processors 2010 can be coupled to other hardware devices, for example, with the use of a bus, such as a PCI bus or SCSI bus. The processors 2010 can communicate with a hardware controller for devices, such as for a display 2030. Display 2030 can be used to display text and graphics. In some implementations, display 2030 provides graphical and textual visual feedback to a user. In some implementations, display 2030 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2040 can also be coupled to the processor, such as a network card, video card, audio card, USB, firewire or other external device, camera, printer, speakers, CD-ROM drive, DVD drive, disk drive, or Blu-Ray device.

In some implementations, the device 2000 also includes a communication device capable of communicating wirelessly or wire-based with a network node. The communication device can communicate with another device or a server through a network using, for example, TCP/IP protocols. Device 2000 can utilize the communication device to distribute operations across multiple network devices.

The processors 2010 can have access to a memory 2050 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2050 can include program memory 2060 that stores programs and software, such as an operating system 2062, content management system 2064, and other application programs 2066. Memory 2050 can also include data memory 2070, which can be provided to the program memory 2060 or any element of the device 2000.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

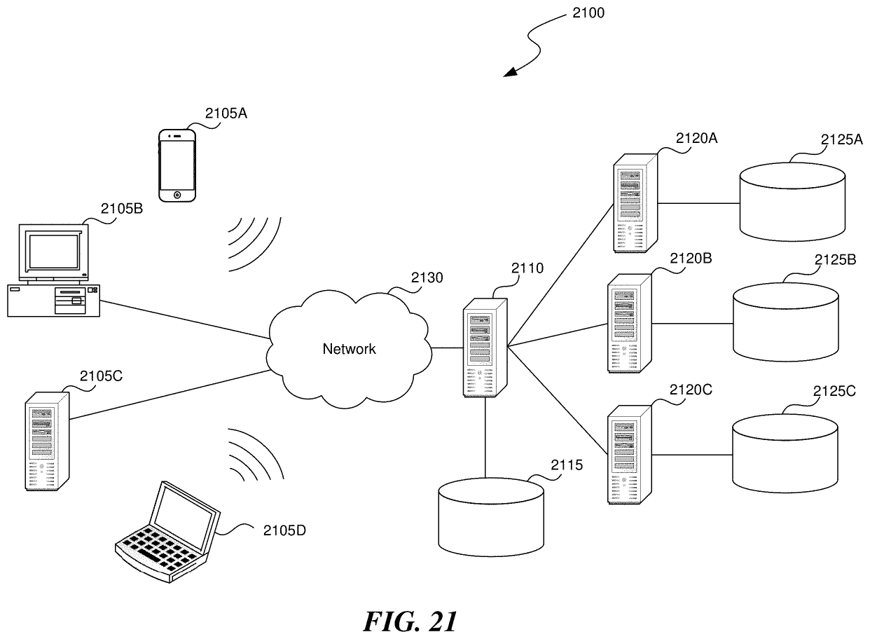

FIG. 21 is a block diagram illustrating an overview of an environment 2100 in which some implementations of the disclosed technology can operate. Environment 2100 can include one or more client computing devices 2105A-D, examples of which can include device 2000. Client computing devices 2105 can operate in a networked environment using logical connections through network 2130 to one or more remote computers, such as a server computing device.

In some implementations, server 2110 can be an edge server which receives client requests and coordinates fulfillment of those requests through other servers, such as servers 2120A-C. Server computing devices 2110 and 2120 can comprise computing systems, such as device 2000. Though each server computing device 2110 and 2120 is displayed logically as a single server, server computing devices can each be a distributed computing environment encompassing multiple computing devices located at the same or at geographically disparate physical locations. In some implementations, each server 2120 corresponds to a group of servers.

Client computing devices 2105 and server computing devices 2110 and 2120 can each act as a server or client to other server/client devices. Server 2110 can connect to a database 2115. Servers 2120A-C can each connect to a corresponding database 2125A-C. As discussed above, each server 2120 can correspond to a group of servers, and each of these servers can share a database or can have their own database. Databases 2115 and 2125 can warehouse (e.g., store) information. Though databases 2115 and 2125 are displayed logically as single units, databases 2115 and 2125 can each be a distributed computing environment encompassing multiple computing devices, can be located within their corresponding server, or can be located at the same or at geographically disparate physical locations.

Network 2130 can be a local area network (LAN) or a wide area network (WAN), but can also be other wired or wireless networks. Network 2130 may be the Internet or some other public or private network. Client computing devices 2105 can be connected to network 2130 through a network interface, such as by wired or wireless communication. While the connections between server 2110 and servers 2120 are shown as separate connections, these connections can be any kind of local, wide area, wired, or wireless network, including network 2130 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, a method for augmenting a digital environment with an NFT, the method comprising: connecting to a non-fungible token (NFT) wallet of a user; retrieving, for the NFT wallet, corresponding NFT content; importing the NFT content into a digital environment; receiving a selection of a plane within the digital environment for attachment of the NFT content; and attaching the NFT content as a world-locked item within the digital environment.

I/we claim:

1. A method for creating a virtual object based on user container selections, the method comprising:
receiving an artificial reality container selection;
receiving one or more content items for the selected artificial reality container;
receiving values for one or more parameters defined for the artificial reality container; and
building a virtual object by applying the received one or more content items and one or more parameter values to the received artificial reality container.

2. A method for generating and exporting non-fungible tokens using object recognition, the method comprising:
receiving at least one image;
automatically recognizing one or more objects within the at least one image using one or more machine learning models;
generating A) a digital item, according to a selected one of the recognized one or more objects, comprising a data representation of the selected one of the recognized one or more objects and B) a non-fungible token that supports transactions for the digital item;
altering the digital item according to a style protocol for a selected digital environment; and
exporting the altered digital item to the one or more digital environments.

3. A method for recommending a product, the method comprising:
selecting one or more first products corresponding to one or more first topics for a current context, the first topics determined from a user interest profile of a user that is based on context when the user engaged in activities;
comparing the one or more first topics to a plurality of second topics corresponding to other anonymous user interest profiles;
selecting, based on the plurality of second topics, one or more second products; and
generating one or more recommendations comprising the one or more first and second products.
